(19) United States
(12) Patent Application Publication
(10) Pub. No.: US 2015/0081425 A1
(43) Pub. Date: Mar. 19, 2015

(54) MULTIPLE-ENTITY TEMPORAL BUDGET OPTIMIZATION IN ONLINE ADVERTISING

(71) Applicant: Kenshoo Ltd., Tel Aviv (IL)

(72) Inventors: Shahar Siegman, Tel Aviv (IL); Adiel Loinger, Givat Shmuel (IL); Moti Meir, Modi'in (IL); Mervyn Kaplan, Givatayim (IL); Jacob H. Oaknin, Bat Hefer (IL)

(21) Appl. No.: 14/551,212

(22) Filed: Nov. 24, 2014

Related U.S. Application Data
(63) Continuation-in-part of application No. 14/155,522, filed on Jan. 15, 2014.
(60) Provisional application No. 61/753,492, filed on Jan. 17, 2013.

(51) Int. Cl. G06Q 30/02

(52) U.S. Cl. CPC G06Q 30/0249; G06Q 30/0247
USPC 705/14.46

(57) ABSTRACT

Temporal budget optimization in online advertising, comprising: receiving a user selection of a time period in the future and of a joint budget for M online ad entities, wherein M≧2; forecasting, based on historical data associated with the M online ad entities, a future ROI function of each of the M online ad entities, wherein the future ROI function provides revenue as a function of cost; computing individual budgets for the M online ad entities by finding M points to serve as the individual budgets, each of the M points being a certain cost in the future ROI function of a different one of the M online ad entities, such that: the M points have approximately equal derivatives, and a sum of the costs at the M points is approximately equal to the joint budget; and during the time period: tracking a spending of the individual budgets, to determine remaining individual budgets, periodically updating the future ROI functions based on newly-accumulated historical data associated with the M online ad entities, and periodically adjusting, in an online advertising platform, a spending pace of the remaining individual budgets, wherein the adjusting is based on the updated future ROI functions.

### CROSS-REFERENCE TO RELATED APPLICATIONS

This application is a continuation-in-part of U.S. patent application Ser. No. 14/155,522, filed Jan. 14, 2014 and entitled “Temporal Budget Optimization in Online Advertising”, which is incorporated herein by reference in its entirety.

### FIELD OF THE INVENTION

Embodiments of the disclosure relate to the field of online advertising.

### BACKGROUND

Advertising using traditional media, such as television, radio, newspapers and magazines, is well known. Unfortunately, even when armed with demographic studies and entirely reasonable assumptions about the typical audience of various media outlets, advertisers recognize that much of their advertising budget is oftentimes simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their advertisements (also “ads”) to a receptive audience. That is, targeted ads are more likely to be useful to end users since the ads may be relevant to a need inferred from some user activity (e.g., relevant to a user's search query to a search engine, relevant to content in a document requested by the user, etc.). Query keyword targeting has been used by search engines to deliver relevant ads. For example, the AdWords advertising system by Google Inc. of Mountain View, Calif., delivers ads targeted to keywords from search queries. Similarly, content targeted ad delivery systems have been proposed. For example, U.S. Pat. No. 7,716,161 to Dean et al. and U.S. Pat. No. 7,136,875 to Anderson et al. describe methods and apparatuses for serving ads relevant to the content of a document, such as a web page. Content-targeted ad delivery systems, such as the AdSense advertising system by Google for example, have been used to serve ads on web pages.

AdSense is part of what is often called advertisement syndication, which allows advertisers to extend their marketing reach by distributing advertisements to additional partners. For example, third party online publishers can place an advertiser's text or image advertisements on web pages that have content related to the advertisement. This is often referred to as “contextual advertising”. As the users are likely interested in the particular content on the publisher web page, they are also likely to be interested in the product or service featured in the advertisement. Accordingly, such targeted advertisement placement can help drive online customers to the advertiser's website.

Optimal ad placement has become a critical competitive advantage in the Internet advertising business. Consumers are spending an ever-increasing amount of time online, looking for information. The information, provided by Internet content providers, is viewed on a page-by-page basis. Each page can contain written and graphical information as well as one or more ads. Key advantages of the Internet, relative to other information media, are that each page can be customized to fit a customer profile and ads can contain links to other Internet pages. Thus, ads can be directly targeted at different customer segments. For example, ad targeting is nowadays possible based on the geographic location of the advertiser and/or the customer, the past navigation path of the customer outside or within the web site, the language used by the visitor's web browser, the purchase history on a website, the behavioral intent influenced by the user's action on the site, and more.

Furthermore, the ads themselves are often designed and positioned to form direct connections to well-designed Internet pages. The concept referred to as “native advertising” offers ads which more naturally blend into a page's design, in cases where advertiser's intent is to make the paid advertising feel less intrusive and, therefore, increase the likelihood users will click on it.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

One embodiment provides a method for temporal budget optimization in online advertising, the method comprising using at least one hardware processor for: receiving a user selection of a time period in the future and of a joint budget for M online ad entities, wherein M≧2; forecasting, based on historical data associated with the M online ad entities, a future return on investment (ROI) function of each of the M online ad entities, wherein the future ROI function provides revenue as a function of cost; computing individual budgets for the M online ad entities for the time period, by finding M points to serve as the individual budgets, each of the M points being a certain cost in the future ROI function of a different one of the M online ad entities, such that: (i) the M points have approximately equal derivatives, and (ii) a sum of the costs at the M points is approximately equal to the joint budget; and during the time period: (a) tracking a spending of the individual budgets, to determine remaining individual budgets, (b) periodically updating the future ROI functions and the individual budgets, based on newly-accumulated historical data associated with the M online ad entities and on the remaining individual budgets, and (c) periodically adjusting, in an online advertising platform, a spending pace of the remaining individual budgets, wherein the adjusting is based on the updated future ROI functions and the updated individual budgets.

Another embodiment provides a computer program product for temporal budget optimization in online advertising, the computer program product comprising a non-transitory computer-readable storage medium having program code embodied therewith, the program code executable by at least one hardware processor for: receiving a user selection of a time period in the future and of a joint budget for M online ad entities, wherein M≧2; forecasting, based on historical data associated with the M online ad entities, a future return on investment (ROI) function of each of the M online ad entities, wherein the future ROI function provides revenue as a function of cost; computing individual budgets for the M online ad entities for the time period, by finding M points to serve as the individual budgets, each of the M points being a certain cost in the future ROI function of a different one of the M online ad entities, such that: (i) the M points have approximately equal derivatives, and (ii) a sum of the costs at the M points is approximately equal to the joint budget; and during the time period: (a) tracking a spending of the individual budgets, to determine remaining individual budgets, (b) periodically updating the future ROI functions and the individual budgets, based on newly-accumulated historical data associated with the M online ad entities and on the remaining individual budgets, and (c) periodically adjusting, in an online advertising platform, a spending pace of the remaining individual budgets, wherein the adjusting is based on the updated future ROI functions and the updated individual budgets.

A further embodiment provides a system for temporal budget optimization in online advertising, the system comprising: at least one hardware processor; and a non-transitory computer-readable storage medium having program code embodied therewith, the program code executable by said at least one hardware processor for: receiving a user selection of a time period in the future and of a joint budget for M online ad entities, wherein M≧2; forecasting, based on historical data associated with the M online ad entities, a future return on investment (ROI) function of each of the M online ad entities, wherein the future ROI function provides revenue as a function of cost; computing individual budgets for the M online ad entities for the time period, by finding M points to serve as the individual budgets, each of the M points being a certain cost in the future ROI function of a different one of the M online ad entities, such that: (i) the M points have approximately equal derivatives, and (ii) a sum of the costs at the M points is approximately equal to the joint budget; and during the time period: (a) tracking a spending of the individual budgets, to determine remaining individual budgets, (b) periodically updating the future ROI functions and the individual budgets, based on newly-accumulated historical data associated with the M online ad entities and on the remaining individual budgets, and (c) periodically adjusting, in an online advertising platform, a spending pace of the remaining individual budgets, wherein the adjusting is based on the updated future ROI functions and the updated individual budgets.

In some embodiments, the forecasting of the future ROI function of each of the M online ad entities comprises: fetching the historical data associated with the M online ad entities, wherein the historical data comprises historical cost time-series and historical revenue time-series; correlating the historical revenue time-series to the historical cost time-series, to produce correlated historical data; and applying a nonlinear curve fitting algorithm to the correlated historical data, to produce a nonlinear function approximately descriptive of the correlated historical data, wherein, in the nonlinear function, revenue is a function of cost, and wherein the nonlinear function is the future ROI function.

In some embodiments, the method further comprises using the at least one hardware processor for computing error bounds of the nonlinear function, based on residuals of the application of the nonlinear curve fitting algorithm to the correlated historical data.

In some embodiments, the program code is further executable for computing error bounds of the nonlinear function, based on residuals of the application of the nonlinear curve fitting algorithm to the correlated historical data.

In some embodiments, the time period is selected from the group consisting of: up to a week, up to multiple weeks, up to a month and up to multiple months.

In some embodiments, the method further comprises using the at least one hardware processor for receiving a schedule of one or more future business events expected to occur during the time period, wherein the adjusting is further based on the schedule.

In some embodiments, the program code is further executable for receiving a schedule of one or more future business events expected to occur during the time period, wherein the adjusting is further based on the schedule.

In some embodiments, the receiving of the schedule comprises receiving a business prediction as to each of the one or more future business events.

In some embodiments, the adjusting of the spending pace of the remaining individual budgets comprises adjusting bids associated with at least one of the M online ad entities.

In some embodiments, the M online ad entities are each selected from the group consisting of: an individual ad, a group of ads, a campaign and a set of campaigns.

Yet a further embodiment provides a method for temporal budget optimization in online advertising, the method comprising using at least one hardware processor for: receiving a user selection of a time period in the future; computing an optimal budget distribution between M online ad entities, wherein said computing comprises: (a) forecasting, based on historical data associated with the M online ad entities, future return on investment (ROI) functions of the M online ad entities for the time period, wherein each of the future ROI functions provides revenue as a function of cost, (b) finding M points to serve as the individual budgets, each of the M points being on a certain cost in the future ROI function of a different one of the M online ad entities, such that the M points have approximately equal derivatives; forecasting, based on the M points found, a joint future ROI function of the M online ad entities; receiving a user selection of a certain point on a graph of the future joint ROI function, and setting a cost at the certain point as a joint budget for the M online ad entities for the time period; determining the individual budgets based on the user selection of the point on the graph of the future joint ROI function; and during the time period: (c) tracking a spending of the individual budgets, to determine remaining individual budgets, (d) periodically updating the future ROI functions and the individual budgets, based on newly-accumulated historical data associated with the M online ad entities and on the remaining individual budgets, and (e) periodically adjusting, in an online advertising platform, a spending pace of the remaining individual budgets, wherein the adjusting is based on the updated future ROI functions and the updated individual budgets.

Another embodiment provides a computer program product for temporal budget optimization in online advertising, the computer program product comprising a non-transitory computer-readable storage medium having program code embodied therewith, the program code executable by at least one hardware processor for: receiving a user selection of a time period in the future; computing an optimal budget distribution between M online ad entities, wherein said computing comprises: (a) forecasting, based on historical data associated with the M online ad entities, future return on investment (ROI) functions of the M online ad entities for the time period, wherein each of the future ROI functions provides revenue as a function of cost, (b) finding M points to serve as the individual budgets, each of the M points being on a certain cost in the future ROI function of a different one of the M online ad entities, such that the M points have approximately equal derivatives; forecasting, based on the M points found, a joint future ROI function of the M online ad entities; receiving a user selection of a certain point on a graph of the future joint ROI function, and setting a cost at the certain point as a joint budget for the M online ad entities for the time period; determining the individual budgets based on the user selection of the point on the graph of the future joint ROI function; and during the time period: (c) tracking a spending of the individual budgets, to determine remaining individual budgets, (d) periodically updating the future ROI functions and the individual budgets, based on newly-accumulated historical data associated with the M online ad entities and on the remaining individual budgets, and (e) periodically adjusting, in an online advertising platform, a spending pace of the remaining individual budgets, wherein the adjusting is based on the updated future ROI functions and the updated individual budgets.

A further embodiment provides a system for temporal budget optimization in online advertising, the system comprising: at least one hardware processor; and a non-transitory computer-readable storage medium having program code embodied therewith, the program code executable by said at least one hardware processor for: receiving a user selection of a time period in the future; computing an optimal budget distribution between M online ad entities, wherein said computing comprises: (a) forecasting, based on historical data associated with the M online ad entities, future return on investment (ROI) functions of the M online ad entities for the time period, wherein each of the future ROI functions provides revenue as a function of cost, (b) finding M points to serve as the individual budgets, each of the M points being on a certain cost in the future ROI function of a different one of the M online ad entities, such that the M points have approximately equal derivatives; forecasting, based on the M points found, a joint future ROI function of the M online ad entities; receiving a user selection of a certain point on a graph of the future joint ROI function, and setting a cost at the certain point as a joint budget for the M online ad entities for the time period; determining the individual budgets based on the user selection of the point on the graph of the future joint ROI function; and during the time period: (c) tracking a spending of the individual budgets, to determine remaining individual budgets, (d) periodically updating the future ROI functions and the individual budgets, based on newly-accumulated historical data associated with the M online ad entities and on the remaining individual budgets, and (e) periodically adjusting, in an online advertising platform, a spending pace of the remaining individual budgets, wherein the adjusting is based on the updated future ROI functions and the updated individual budgets.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. It is intended that the embodiments and figures disclosed herein are to be considered illustrative rather than restrictive. The figures are listed below.

FIG. 1 shows a schematic of an exemplary a cloud computing node;

FIG. 2 shows an illustrative cloud computing environment;

FIG. 3 shows a set of functional abstraction layers provided by the cloud computing environment;

FIG. 4 shows a flow chart of a method for temporal budget optimization in online advertising;

FIG. 5 shows an exemplary user interface for use with the method of FIG. 4;

FIG. 6 shows a flow chart of a first variation of the method of FIG. 4; and

FIG. 7 shows a flow chart of a second variation of the method of FIG. 4.

### DETAILED DESCRIPTION

Disclosed herein is a method for temporal budget optimization in online advertising. The method, given an advertising budget set by an advertiser, may monitor a spending of the budget over time, and automatically adjust its spending pace whenever needed. Advantageously, the adjustment is enabled by a forecasting of a return on investment (ROI) associated with the budget. The adjustment may ultimately lead to an optimization of the budget, or, at least, to a better utilization of the budget compared to a spending without any periodic adjustment.

Additionally disclosed is variation of the above method, in which the temporal budget optimization is made for multiple ad entities. This variation of the method is especially advantageous for cases where an advertiser wishes to maximize the use of resources (i.e. budget) for funding multiple ad entities over time. The advantage of this is twofold: it allows both to perform an initial, optimized division of the budget between the multiple ad entities, and to adjust that division over time, to make sure the resources continue to be spent optimally.

### GLOSSARY

“Online advertising platform” (or simply “advertising platform”): This term, as referred to herein, may relate to a service offered by an advertising business to different advertisers. In the course of this service, the advertising business serves ads, on behalf of the advertisers, to Internet users. Each advertising platform usually services a large number of advertisers, who compete on advertising resources available through the platform. The competition is oftentimes carried out by conducting some form of an auction, where advertisers bid on advertising resources. The ads may be displayed (and/or otherwise presented) in various web sites which are affiliated with the advertising business (these web sites constituting what is often referred to as a “display network”) and/or in one or more web sites operated directly by the advertising business. To aid advertisers in neatly organizing their ads, advertising platforms often allow grouping individual ads in sets, such as the “AdGroups” feature in Google AdWords (a service operated by Google, Inc. of Mountain View, Calif.). The advertiser may decide on the logic behind such grouping, but it is common to have ads grouped by similar ad copies, similar targeting, etc. Advertising platforms may allow an even more abstract way to group ads; this is often called a “campaign”. A campaign usually includes multiple sets of ads, with each set including multiple ads. An advertiser may control the cost it spends on online advertising by assigning a budget per individual ad, a group of ads or the like. The budget may be defined for a certain period of time.

“Search advertising platform”: A type of advertising platform in which ads are served to Internet users responsive to search engine queries executed by the users. The ads are typically displayed alongside the results of the search engine query. AdWords is a prominent example of a search advertising platform. In AdWords, advertisers can choose between displaying their ads in a display network and/or in Google's own search engine; the former involves the subscription of web site operators (often called “publishers”) to Google's AdSense program, whereas the latter, often referred to as SEM (Search Engine Marketing), involves triggering the displaying of ads based on keywords entered by users in the search engine.

“Social advertising platform”: A further type of advertising platforms, commonly referred to as a “social” advertising platform, involves the displaying of ads to users of online social networks. An online social network is often defined as a set of dyadic connections between persons and/or organizations, enabling these entities to communicate over the Internet. In social advertising, both the advertisers and the users enjoy the fact that the displayed ads can be highly tailored to the users viewing them. This feature is enabled by way of analyzing various demographics and/or other parameters of the users (jointly referred to as “targeting criteria”)—parameters which are readily available in many advertising platforms of social networks and are usually provided by the users themselves. Facebook Ads, operated by Facebook, Inc. of Menlo Park, Calif., is such an advertising platform. LinkedIn Ads, by LinkedIn Corporation of Mountain View, Calif., is another.

“Online ad entity” (or simply “ad entity”): This term, as referred to herein, may relate to an individual ad, or, alternatively, to a set of individual ads, run by an advertising platform. An individual ad, as referred to herein, may include an ad copy, which is the text, graphics and/or other media to be served (displayed and/or otherwise presented) to users. In addition, an individual ad or a set of individual ads may include and/or be associated with a set of parameters, such as searched keywords to target, geographies to target, demographics to target, a bid for utilization of advertising resources of the advertising platform, an advertising channel and/or the like. Sometimes, the bid may set for a particular parameter instead of or in addition to setting a global bid for the ad entity; for example, a bid may be per keyword, geography, etc. The term “advertising channel” may refer to a type of an advertising platform in which the ad entity is run. For example, an advertising chancel may be “social” if the ad entity is run in a social advertising platform, and “search” if the ad is run in a search advertising platform. Additionally or alternatively, “advertising channel” may refer to a sub-type of advertising within a certain advertising platform. For example, a search advertising platform may include a channel which targets users who perform search queries in a search engine, and a separate channel which targets users who visit web pages related to or dealing with a certain topic.

“Reach”: the number of users which fit certain targeting criteria of an ad entity. This is the number of users to which that ad entity can be potentially displayed. The “reach” metric is common in social advertising platforms, such as Facebook.

“Search volume”: the number of average monthly searches (or searches over another period of time) for a certain search term. The search volume is often provided by search advertising platforms, such as Google AdWords.

“Performance”: This term, as referred to herein with regard to an ad, may relate to various statistics gathered in the course of running the ad. A “running” phase of the ad may refer to a duration in which the ad was served to users, or at least to a duration during which the advertiser defined that the ad should be served. The term “performance” may also relate to an aggregate of various statistics gathered for a set of ads, a campaign, etc. The statistics may include multiple parameters (also “performance metrics”). Exemplary performance metrics are:
“Impressions”: the number of times the ad has been served to users during a given time period (e.g. a day, an hour, etc.);
“Frequency”: the average number of times a user has been exposed to the same ad, calculated as the ratio of total number of impressions to the number of unique impressions (i.e. the number of unique users exposed to that ad). This metric is very common in social advertising platforms;
“Clicks”: the number of times users clicked (or otherwise interacted with) the ad entity during a given time period (e.g. a day, an hour, etc.);
“Cost per click (CPC)”: the average cost of a click (or another interaction with an ad entity) to the advertiser, calculated as the total cost for all clicks divided by the number of clicks;
“Cost per impression”: the average cost of an impression to the advertiser, calculated as the total cost for all impressions divided by the number of impressions;
“Click-through rate (CTR)”: the ratio between clicks and impressions of the ad entity, namely—the number of clicks divided by the number of impressions;
“Conversions”: the number of times in which users who clicked (or otherwise interacted with) the ad entity have consecutively accepted an offer made by the advertiser during a given time period (e.g. a day, an hour, etc.). For examples, users who purchased an advertised product, users who subscribed to an advertised service, users who downloaded a mobile application, or users who filled in their details in a lead generation form;
“Conversion rate (CR)”: the total number of conversions divided by the total number of clicks;
“Return on investment (ROI)” or “Return on advertising spending (ROAS)”: the ratio between the amount of revenue generated as a result of online advertising, and the amount of investment in those online advertising efforts. Namely—revenue divided by expenses;
“Revenue per click”: the average amount of revenue generated to the advertiser per click (or another interaction with an ad entity), calculated by dividing total revenue by total clicks;
“Revenue per impression”: the average amount of revenue generated to the advertiser per impression of the ad entity, calculated by dividing total revenue by total impressions;
“Revenue per conversion”: the average amount of revenue generated to the advertiser per conversion, calculated by dividing total revenue by total conversions;
“Unique-impressions-to-reach ratio”: the ratio between the number of unique impressions (i.e. impressions by different users, ignoring repeated impressions by the same user) and the reach of the ad entity. This ratio represents the realized portion of the reach.
“Spend rate”: the percentage of utilized budget per a certain time period (e.g. a day) for which the budget was defined. In many scenarios, even if an advertiser assigns a certain budget for a certain period of time, not the entire budget is consumed during that period. The spend rate metric measures this phenomenon.
“Quality score”: a score often provided by advertising platforms for each ad entity. For example, Google AdWords assigns a quality score between 1 and 10 to each individual ad. Factors which determine the quality score include, for example, CTR, ad copy relevance, landing page quality and/or other factors. The quality score, together with the bids placed by the advertiser, are usually the factors which affect the results of the competition between different advertisers on advertising resources.
“Potential reach”: defined as 1 minus the unique-impressions-to-reach ratio. The higher the potential reach, the more users are left to display the ad entity to.

“Proportional performance metrics”: those of the above performance metrics (or other performance metrics not discussed here) which denote a proportion between two performance metrics which are absolute values. Merely as one example, CTR is a proportional performance metric since it denotes the proportion between clicks (an absolute value) and impressions (another absolute value). As an alternative, a proportional performance metric may be a proportion between an absolute performance metric and another parameter, such as time. As yet another alternative, a proportional performance metric may be a certain mathematic manipulation of a proportion between two absolute performance metrics; the “potential reach” is an example, since it is defined as 1 minus the unique-impressions-to-reach ratio.

In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a hardware processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

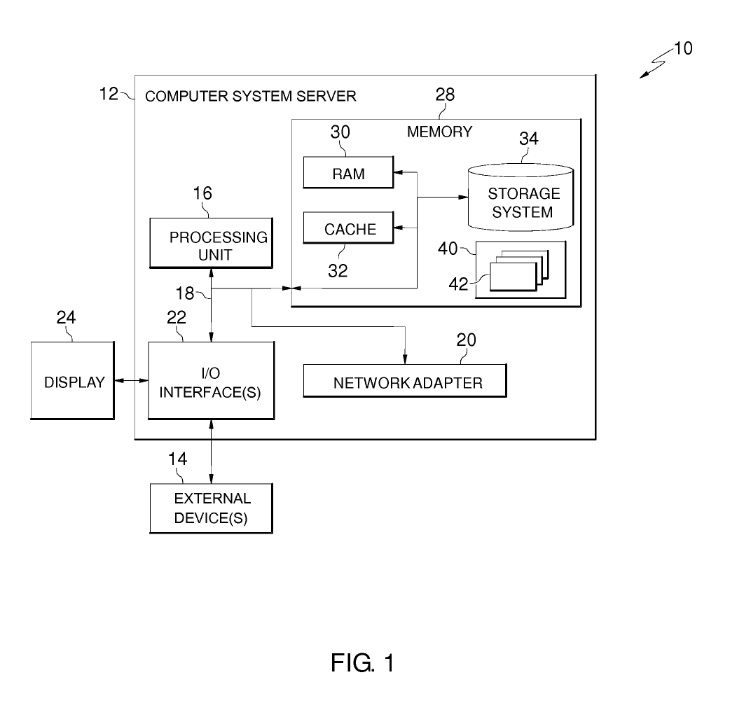

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system.

Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

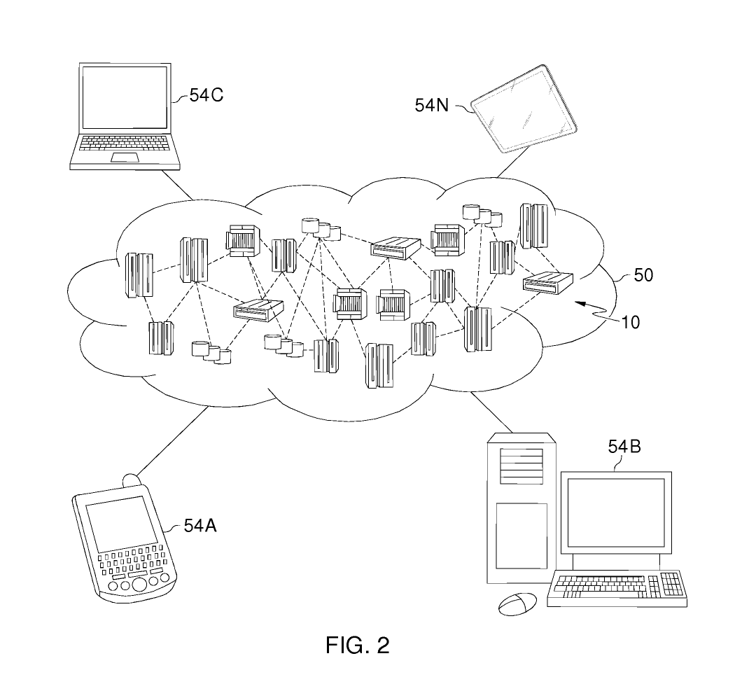

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone MA, desktop computer MB, laptop computer 54C, and/or tablet computing device 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices MA-N shown in FIG. 2 are intended to be illustrative only and that computing nodes 10 and cloud computing environment 50 can communicate with any type of computerized device over any type of network and/or network addressable connection (e.g., using a web browser).

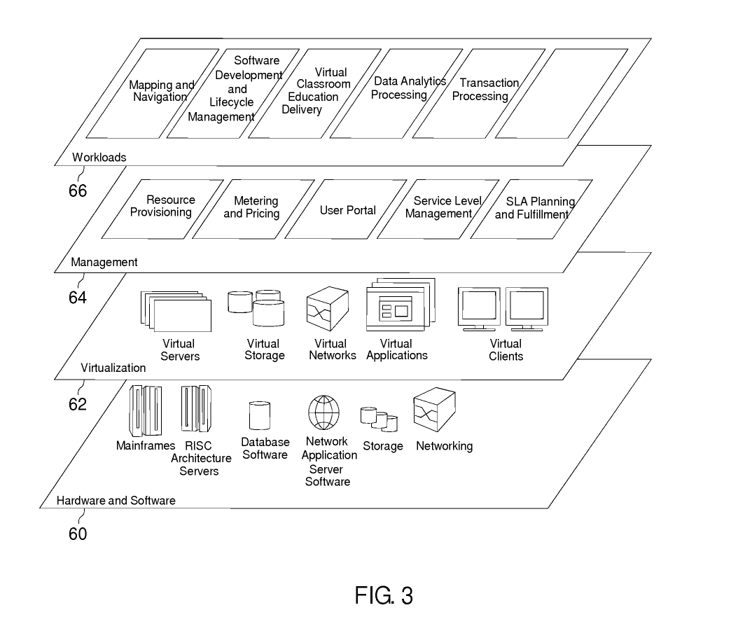

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, RISC (Reduced Instruction Set Computer) architecture based servers; storage devices; networks and networking components. Examples of software components include network application server software; and database software.

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; and data analytics processing; transaction processing.

As briefly discussed above, a method for temporal budget optimization in online advertising is disclosed herein. The method, firstly, may monitor a spending of an advertising budget over time, and periodically adjust its spending pace. Secondly, the method may enable a user acting for the advertiser to set the budget in a convenient and educated manner, using an advantageous user interface (UI). In this UI, the user may be presented with a future ROI function computed according to the method. The user may conveniently select a point on the ROI function which suits the business needs and expectations of the advertiser. The method may then translate the selected point to a monetary value to be used as the budget.

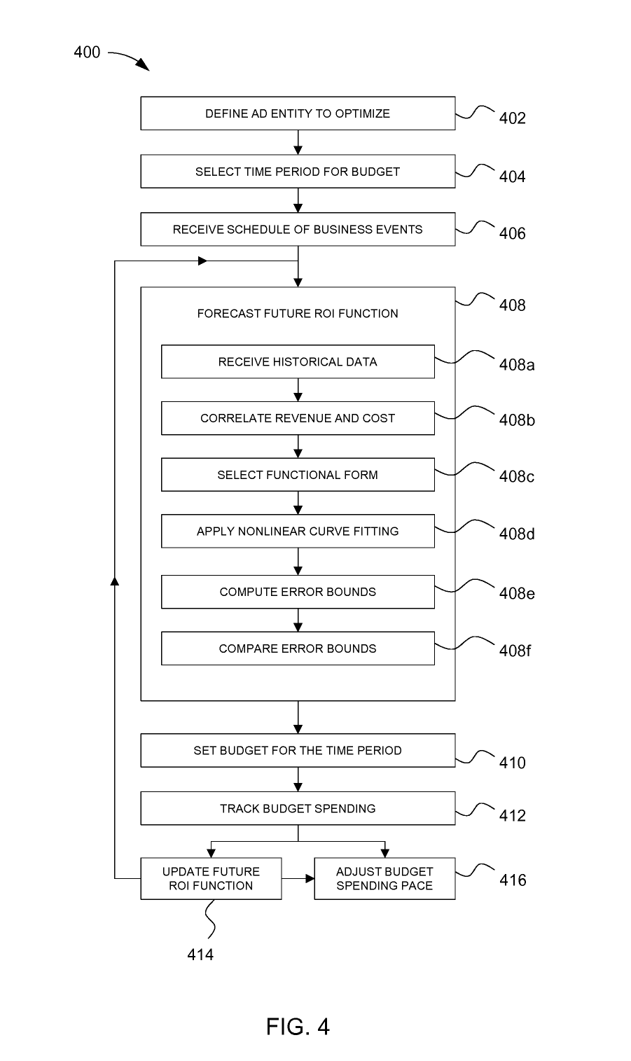

Reference is now made to FIG. 4, which shows a flow chart of a method 400 for temporal budget optimization, in accordance with some embodiments. Steps of method 400 may not necessarily be carried out in the order they are described; those of skill in the art will recognize various other orders in which the steps, or some of them, may be performed. Those skilled in the art will recognize that it may be possible to omit one or more steps of method 400, while still yielding advantageous effects.

In a step 402, a definition of which ad entity the budget is to be optimized for, may be received from a user. For example, the user may be presented with a number of ad entities which are presently active or have been active in one or more advertising platform. The user may choose one of these entities for optimization.

In a step 404, a user selection of a time period in the future may be received. This time period is the one for which the user desires to set an advertising budget. The advertising budget is to be spent in purchasing advertising resources (e.g. the display of ads) from the advertising platform. The time period may span, typically, over a few days (e.g. up to a week), a few weeks (e.g. up to a month) or a few months (e.g. up to a year). The time period may also be considerably shorter (e.g. a few minutes or hours) or much longer (e.g. a number of years). The time period may be defined by the user in various resolutions, such as by defining calendar days, hours, minutes and/or even seconds.

In an optional step 406, a schedule of one or more future business events expected to occur during the time period selected in step 404 may be received. The one or more future business events may be provided by the user and/or be pre-programmed in method 400. Each such future business event may include a definition of its time span, namely a date (and optionally a time) of the beginning of the event and a date (and optionally a time) of the ending of the event. These business events may be times during which the advertiser intends to carry out certain promotions pertaining to its online and/or offline offerings. Additionally or alternatively, these business events may be times which are known in advance to have a certain effect on the behavior of a target audience of the ad entity. Examples include Cyber Monday, Black Friday, “back to school” period, Jewish holiday period, etc.

The schedule may further include a business prediction as to one or more of the future business events. The business prediction is an indication of how such event is expected to affect the ROI associated with the ad entity. The effect on the ROI may be a result of individual effects to the cost and/or revenue. Optionally, the expected effect on each of the cost and the revenue may be defined percentage-wise. For example, for a certain event it may be defined that a +25% change of cost is expected to yield a −10% change in revenue (namely an ROI drop).

The schedule received in step 406 may be later utilized for adjusting an advertising budget spending pace, as further discussed below.

In a step 408, a future ROI function of the online ad entity may be forecasted, based at least on historical data associated with the ad entity defined in step 402. To this end, the historical data may be received 408a from the user, or be fetched from the advertising platform and/or from a database not belonging to the advertising platform but used for storing data collected from the advertising platform and/or from other one or more sources. The historical data may include performance data, specifically those data indicating a cost of advertising and a revenue yielded, directly and/or indirectly, from this advertising. The historical data may be structured as two or more time series—one for historical cost and one for historical revenue. If the historical data is received with a different structure—it may be re-structured in the course of method 400 to contain at least the historical cost time series and the historical revenue time series.

Naturally, as the historical data includes more variance, the forecasting of the future ROI function becomes more reliable. In an extreme case, where the historical cost is more or less the same over an extended period of time, any prediction may be highly unreliable, since it cannot be deduced how changes in the cost affect the revenue. Similarly In the opposite extreme case, where the historical cost varies greatly over the time period, reliable conclusions as to its affects on the revenue may be drawn.

The received historical data may span over a time period which is either selected by the user, or determined automatically by method 400. For example, method 400 may be pre-programmed to receive and/or process historical data covering only a certain period in the past, such as the past week, past month, etc. The historical cost time-series and the historical revenue time-series may each be temporally fragmented; as one example, each time series may have a resolution of a single day. Namely, each point in these time-series indicates the cost or revenue, respectively, accumulated over one day. The resolution may be different, of course; it may be of minutes, hours, days or even more.

The forecasting of the future ROI function may further include a correlating 408b of the historical revenue time-series to the historical cost time-series, in order to align these time series on a mutual time axis. The result of the correlation is correlated historical data—a series of points each defined by a cost (x) and its respective revenue (y), such that y=f(x). Namely—revenue is a function of cost.

Optionally, one or more additional performance metrics, such as impressions, clicks, CTR, CPC or others, may be used for ameliorating the correlation of the historical revenue time-series and the historical cost time-series. This may be done, for example, to account for scenarios in which certain unexplained statistical anomalies are exhibited in one of both these time-series. Usage of the one or more additional performance metrics, as an intermediary between the two time-series, may help explain such anomalies. For example, if the same cost incurred on two different dates, but resulted with completely different revenue figures, then usage of the one or more additional performance metrics may explain this inconsistency, for the ultimate goal of producing a reliable future ROI function. For instance, utilizing the impressions and CPC metrics may reveal that one of these dates included a low volume of impressions compounded by an extremely high CPC (in relation to previous average, for example), thereby making the cost and revenue data for that date statistically insignificant. Consecutively, it may be decided to discard this data. In more moderate scenarios, it may be decided that certain data may need to be adjusted, downwards or upwards, due to insight gathered from the one or more additional performance metrics.

The correlation of the historical revenue time-series to the historical cost time-series does not necessarily mean that these time-series are simply combined based on a mutual time axis. If a tracking mechanism is employed for the collection of performance data, then each revenue-related event (e.g. a purchase by a user) may be attributed to a specific click (which is a cost-related event)—even if that click predated the purchase by minutes, hours, days or even more. Namely, when correlating the two time series, each point in the historical revenue time-series may be correlated with a certain point in the historical cost time-series—even if these points do not have the same X value. If, for example, the resolution of the historical revenue time-series and the historical cost time-series is one day, then each one-day period (i.e. point) in the former will be correlated to a certain one-day period (i.e. point) in the latter.

Then, a desired functional form of the future ROI function may be selected 408c by the user or be determined automatically or arbitrarily. The functional form may be, for example, a polynomial form, a logarithmic form, an exponential form, a trigonometric form or a hyperbolic form. Next, a nonlinear curve fitting algorithm may be applied 408d to the correlated historical data, to produce a nonlinear function approximately descriptive of the correlated historical data, namely—the future ROI function. Nonlinear curve fitting algorithms are known in the art; a prominent example is the Levenberg-Marquardt algorithm (LMA), but other algorithms may be similarly applicable to method 400. The nonlinear curve fitting algorithm may be instructed, using suitable settings, to produce the nonlinear function with the selected functional form.

Optionally, error bounds for the nonlinear function may be computed 408e. Since the nonlinear function is only an approximation of the points of the correlated historical data, it may be desired to indicate to the user what the quality of this approximation is. The error bounds may be computed based on residuals of the application of the nonlinear curve fitting algorithm to the correlated historical data. To deduce the residuals, they values of points in the nonlinear function and the correlated historical data which have the same x value may be compared. The difference between them is the residual of each such point. Then, the error bounds for each point may be computed as the sum of the square value of the residual at that point. However, a different computation of the error bounds based on the residuals is possible.

Optionally, steps 408c, 408d and 408e may be repeated once or a few times, with a manual or automatic selection of a different functional form in each such repetition. Merely as an example, in an initial execution of steps 408c, 408d and 408e, a polynomial form may be selected; in a first repetition of these steps, an exponential form may be selected; in a second repetition of these steps, a hyperbolic form may be selected; and so on and so forth. If automatic selection of the different functional forms is used, then method 400 may be pre-programmed to select different functional forms in a certain sequence. Resulting from this repetition is information as to error bounds of multiple future ROI functions having different functional forms.

If this optional repetition is carried out, then an additional, optional step 408f may include comparing the error bounds of the multiple future ROI functions. The future ROI function having the smallest error bounds may be indicated to the user as the one estimated to be the most reliable. Alternatively, the repetition process may be hidden from the user; instead, the user may only be exposed to that certain future ROI function which was determined to have the smallest error bounds, and the entire repetition and computation of error bounds may be performed in the background. Further alternatively, the user may be shown an average graph of two or more future ROI functions. This, optionally, may be achieved by simple pixel averaging of the graphical image of the two or more future ROI functions, or by a different other mathematical method.

In a step 410, a user selection of a point on the ROI function may be received. By this selection, a budget may be set for the time period selected in step 404, for the ad entity defined in step 402. The budget may be set to an x-axis value of the selected point. Then, optionally, instructions as to this budget may be transmitted to the pertinent advertising platform, based on the manner this advertising platform is configured to handle budgets. For example, if the advertising platform is configured to receive a definition of calendar-month budget and automatically attempt to spread this budget evenly over days of the month, then the budget set in step 410 may be translated to a monthly budget for the advertising platform. A simplistic case is when the budget set in step 410 is for a certain calendar month, as selected by the user is step 404. Then, the instructions to the advertising platform are clear and trivial. However, certain computation may be necessary if a different future time period is selected in step 404, in order to be able to set a monthly budget in the advertising platform that will lead to the spreading of the budget set in step 410 over the future time period selected in step 404. Optionally, the spreading of the budget over the future time period is equal; namely, every sub-time period (e.g. a day) will have the same sub-budget.

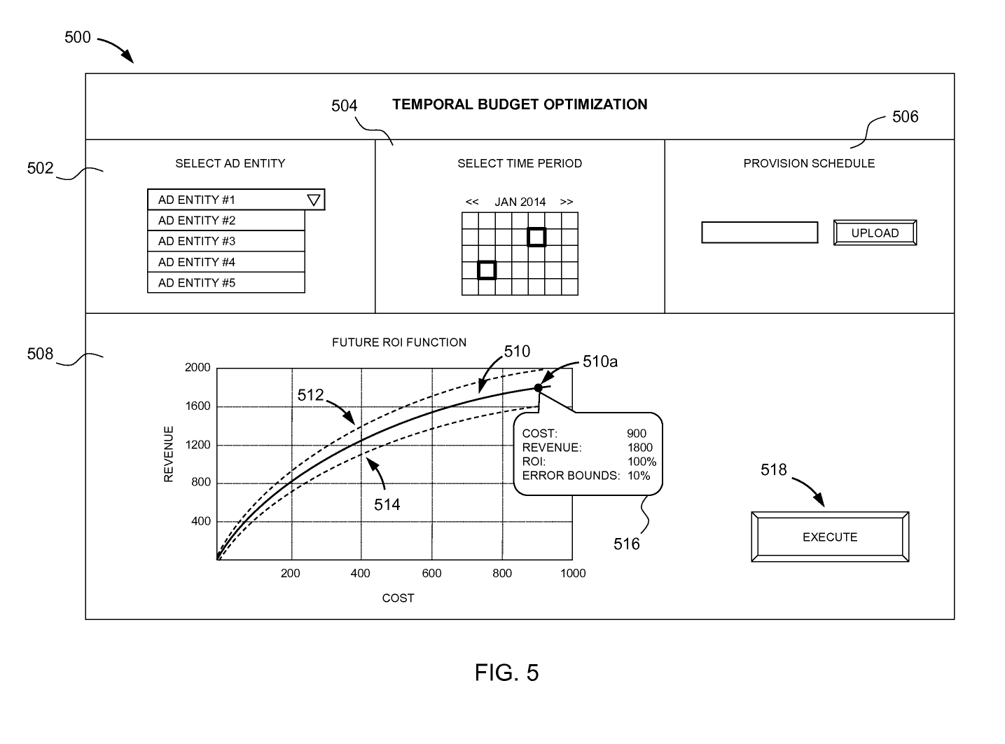

Interim reference is now made to FIG. 5, which shows an exemplary user interface (UI) 500 configured for use in conjunction with method 400 of FIG. 4. UI 500 may include one or more of: an ad entity selection pane 502 for use in accordance with step 402 (FIG. 4); a time period selection pane 504 for use in accordance with step 404 (FIG. 4); a schedule provision pane 506 for use in accordance with step 406 (FIG. 4); and a budget setting pane 508 for use in accordance with step 410 (FIG. 4).

The user may select an ad entity in ad entity selection pane 502, define a future time period in time period selection pane 504, provide a schedule of future business events in optional schedule provision pane 506, and, following the forecasting step 408 (FIG. 4), be presented with a future ROI function graph 510 in budget setting pane 508. Graph 510 is optionally presented alongside the error bounds computed for that specific future ROI function. The error bounds may be displayed, for example, as two curves—one 512 above graph 510 and the other 514 below graph 510.

UI 500 may be configured to allow the user to hover over graph 510 (or to otherwise point at different points on the graph). As the user hovers, an indication of one or more parameters associated with point hovered over may be shown, for example as a tooltip 516. One or more of the following exemplary parameters may be shown: Cost, revenue, ROI (optionally computed as (revenue−cost)/cost), error bounds, etc. The user may, in this manner, review the parameter(s) associated with different points, to learn and understand which parameter(s) are expected when choosing any particular budget. This may enable the user to select the budget which suits the advertiser best, business-wise.

After being presented with the one or more parameters, and optionally after reviewing parameters associated with different points hovered over, the user may make select a point, such as point 510a, on graph 510, thereby setting the budget to the x-axis value of the selected point. In the exemplary UI 500 shown, this value is 900.

Once the budget has been set, execution of method 400 (FIG. 4) may continue. To this end, the user may press an “execute” button 518 or otherwise indicate that a temporal optimization of the set budget is now desired.

Accordingly, reference is now made back to FIG. 4. During the time period selected in step 404, a number of steps may be executed: In a step 412, a spending of the budget may be tracked, for example by periodically interfacing with the advertising platform using an API (Application Programming Interface) thereof, to fetch a value of the budget spent so far or of the budget remaining (if the latter is available in the advertising platform). If the advertising platform only provides the value of the budget spent so far, the remaining budget may be determined by subtracting the value of the budget spent so far from the budget set in step 410. The periodic interfacing may occur, for example, every few minutes, hours, days or more.

In a step 414, the future ROI function may be periodically updated, but not necessarily in accordance with the periodicity of step 412. However, in an alternative embodiment, the periodic updating of the future ROI function is in accordance with the periodicity of step 412. Each such updating of the future ROI function may include a re-executing of the fetching 408a, the correlating 408b, the applying 408d and optionally the selection 408c of the desired functional form. These re-executions may be based on newly-accumulated historical data associated with the online ad entity. With each periodic update, naturally, newer historical data is available, and the future ROI function may be updated based on this new data.

In a step 416, a spending pace of the remaining budget tracked in step 412 may be periodically adjusted, for example by transmitting a suitable instruction to the advertising platform. The periodicity of this adjustment is not necessarily in accordance with the periodicity of step 412 and/or 414. In an alternative embodiment, however, the periodic adjustment of the spending pace is in accordance with the periodicity of step 412 and or/414. The periodic adjustment of the spending pace may be based on the updated future ROI function which is available from a most recent execution of step 414.

The periodic adjustment of the spending pace may include, for example, adjusting one or more bids associated with the ad entity. These bids may be per ad entity, keyword, geography and/or any other parameter for which bidding is possible in the advertising platform. If the spending pace needs to be increased, than the bids may be increased, and vice versa. Additionally or alternatively, if the pertinent advertising platform allows setting a daily budget, then the pacing may include adjusting (i.e. increasing or decreasing) this daily budget. Furthermore, whether bid adjustment and/or daily budget adjustment is performed, it may be possible to periodically adjust these parameters in order to compensate for any inaccuracies in the spending over a previous period of time. Merely as an example, if the spending in day no. 1 was $500 lower than what it should have, then the bids and/or daily budget for day no. 2 may be increased by $500 to compensate for the previous day.

Optionally, the periodic adjustment of the spending pace may be further based on the schedule received in step 406. Namely, the spending pace may be increased during events which are expected to have a positive effect on the utility of the advertiser, and be decreased during opposite events. Optionally, the spending pace is adjusted based on the business prediction received with the schedule.

At every point during the time period when any of steps 412, 414 and 416 is executed, the user may be provided with the option to cease the execution of method 400 and to start from scratch; namely, to change the previous selections of ad entity, time period, budget and/or the like. This will initiate a new budget optimization process.

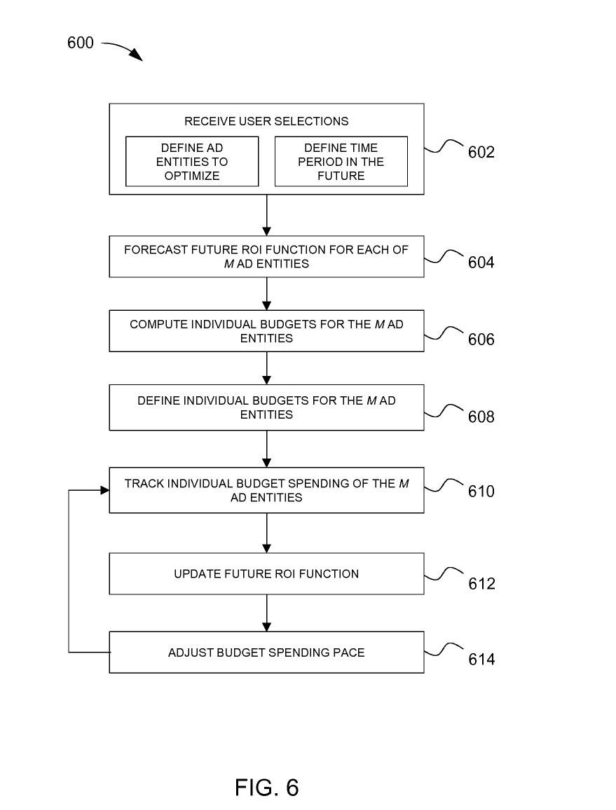

In some embodiments, a variation of method 400 is employed, to adapt the method for temporal budget optimization of multiple ad entities, as opposed to a single one in method 400. Reference is now made to FIG. 6, which shows a flow chart of that variation 600. Being a variation of method 400 (FIG. 4), variation 600 is discussed in more brevity; those of skill in the art will recognize those more thorough discussions in method 400 which also apply here, to its variation 600.

In a step 602, user selections may be received. These user selections may include a definition of a time period in the future, a definition of which ad entities should be budget-optimized, and a definition of a joint budget for all of these ad entities. The number of ad entities selected, denoted here as M, may be 2 or larger.

In a step 604, a future ROI function may be forecasted for each of the M ad entities, based on historical data associated with each ad entity, respectively. Namely, M future ROI function may be produced.

In a step 606, individual budgets for the M ad entities may be computed, as follows: M points may be found, one on each of the M future ROI functions, where each of the points denotes a certain cost on its respective future ROI function. The M points are found such that they satisfy the following conditions: first, they have approximately equal derivatives. This ensures, according to the well-known equal marginal benefit principle, that the advertiser's marginal utility per a unit of cost (e.g. a dollar) is equal across all M ad entities. This equality means that the advertiser's use of its budget for the M ad entities is optimal. Second, the sum of costs at the M points is approximately equal to the joint budget selected in step 602. In some embodiments, the term “approximately”, as referred to herein, refers to no more than a ±20% difference between the derivatives, or to no more than a ±20% deviation from the selected joint budget, correspondingly. In other embodiments, the difference and/or the deviation referred to above may exceed ±20%.

In a step 608, the found M points are defined as the individual budgets for the M ad entities. For example, these individual budgets may be automatically transmitted to an advertising platform in which the M ad entities reside, using an API (Application Programming Interface) of the platform—as known in the art.

In a step 610, carried out after the Mad entities have started running in the advertising platform, the spending of the individual budgets may be tracked. The tracking may be performed, for example, by automatically and periodically interfacing with the API of the advertising platform. The tracking of the spending may result in a determination of the remaining individual budgets.

In a step 612, which may be performed periodically, the M future ROI functions may be updated, based on historical data which was newly-accumulated during the time period since the Mad entities have started running; in addition, the individual budgets may also be updated, consecutively to the updating the of future ROI functions, and given the remaining individual budgets.

In a step 614, a spending pace of the remaining individual budgets may be periodically adjusted, based on the updated future ROI functions and the updated individual budgets. Namely, if the updating of the future ROI functions and the consecutive updating of the individual budgets reveal that the budget is being spent too fast (so that it will not suffice for running the ad entities for the entire time period) or too slow (so that it will not be entirely spent during the time period), the spending pace may be decreased or increased, respectively.

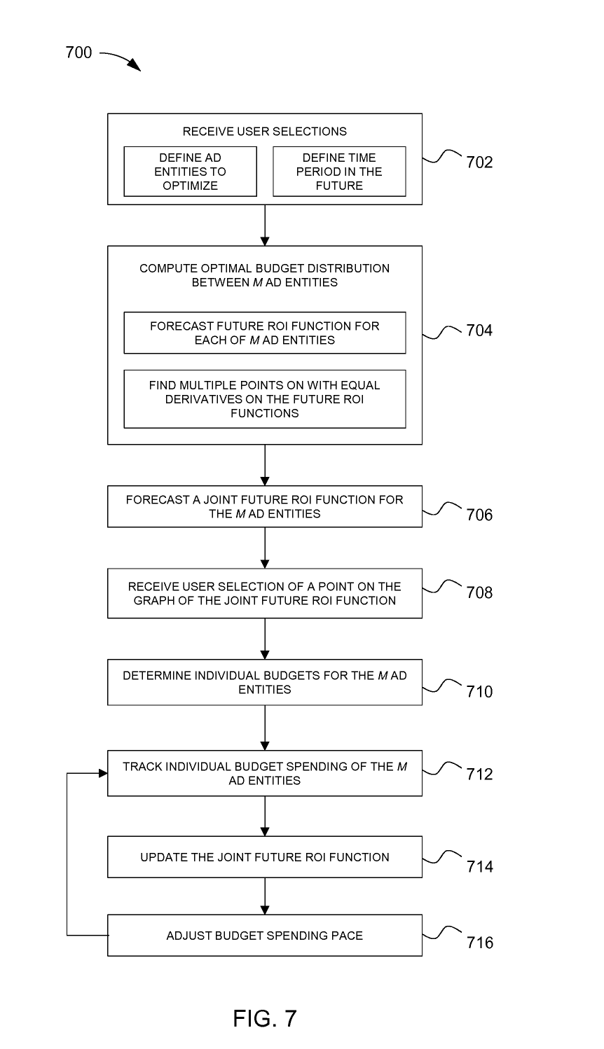

In some embodiments, a second variation of method 400 is employed, to both (a) adapt the method for temporal budget optimization of multiple ad entities, as opposed to a single one in method 400, and (b) automatically suggest to the advertiser a joint budget for its multiple ad entities. Reference is now made to FIG. 7, which shows a flow chart of that second variation 700. Being a variation of method 400 (FIG. 4), variation 700 is discussed in more brevity; those of skill in the art will recognize those more thorough discussions in method 400 which also apply here, to its variation 700. In a step 702, user selections may be received. These user selections may include a definition of a time period in the future, and a definition of which ad entities should be budget-optimized. The number of ad entities selected, denoted here as M, may be 2 or larger.

In a step 704, an optimal budget distribution between the M ad entities may be computed as follows: First, multiple future ROI functions may be forecasted, one for each of the Mad entities, based on historical data associated with the respective ad entity. Second, multiple points are found, each being a certain cost in the future ROI function of a different one of the M online ad entities. The multiple points satisfy the condition of having approximately equal derivatives. Typically, at least a few such points are found on the future ROI function of each online ad entity. Sometimes, tens such points or even more may be found on the future ROI function of each online ad entity.

In a step 706, a joint future ROI function of the Mad entities may be forecasted, based on the multiple points found. This forecasting, in an embodiment, may be conducted using the following computation steps:

First, for purposes of the computation, each curve of the multiple future ROI functions may be assigned a different denomination. For example, if two multiple future ROI functions exist, their curved may be denoted A and B. Each of these curves may be comprised of multiple cost-revenue pairs, namely, an X value which is the cost and a Y value which is the revenue.

Then, each of curves A and B may be divided into a relatively large number (N) of X-Y points, for example tens of point, hundreds of points, or even thousands of points—the points being optionally spaced apart equally over the X axis. Those points of curve A, for instance, may be denoted (XA₁,YA₁), (XA₂,YA₂), . . . . , (XA_{N},YA_{N}), and those of curve B—(XB₁, YB₁), (XB₂,YB₂), . . . , (XB_{N},YB_{N}).

Next, all N points of curves A and B are derived. Then, a search commences for points having approximately the same derivative. For instance, for point (XA₁,YA₁), a search over all points of curve B which have approximately the same derivative as point (XA₁,YA₁) is performed. The points found in the search are then combined. By way of example, if it has been found that point (XB₇,YB₇) has approximately the same derivative as (XA₁,YA₁), these two points may be combined into a new point XC₁,YC₁), where XC₁=XA₁+XB₇ and YC₁=YA₁+YB₇. This process continues for all N points of curves A and B, so as to yield a series of X-Y points which make up a new curve C. Curve C is the joint future ROI function of the M ad entities.

It should be noted that, instead of deriving all N points of curves A and B and only then commencing the search, it is possible to derive each point only when the search reaches it.

In a step 708, a user selection of a certain point on a graph of the future joint ROI function may be received. To this end, a UI, such as UI 500 of FIG. 5, may be employed. That UI may also be employed for receiving the user selections of step 702. For the purpose of step 708, a user may select, for example, point 510a on graph 510 (being, in this case, the future joint ROI function), thereby setting a joint budget for the Mad entities as the cost value at that point.

In a step 710, the individual budgets for the M ad entities may be determined, based on the user selection of step 708; the point selected by the user may be backtraced to its respective M points found in step 704, such that the cost at the selected point, which is the joint budget, approximately equals the sum of costs at these M points.

From here, variation 700 may proceed to track 712 the spending of the individual budgets, update the joint future ROI function 714, and adjust the spending pace 716, similar to the discussion of steps 610, 612 and 614 (FIG. 6) above, respectively.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise” “include” and “have”, and forms thereof, are not necessarily limited to members in a list with which the words may be associated.

What is claimed is:

1. A method for temporal budget optimization in online advertising, the method comprising using at least one hardware processor for:
receiving a user selection of a time period in the future and of a joint budget for M online ad entities, wherein M≧2;
forecasting, based on historical data associated with the M online ad entities, a future return on investment (ROI) function of each of the M online ad entities, wherein the future ROI function provides revenue as a function of cost;
computing individual budgets for the M online ad entities for the time period, by finding M points to serve as the individual budgets, each of the M points being a certain cost in the future ROI function of a different one of the M online ad entities, such that:
(i) the M points have approximately equal derivatives, and
(ii) a sum of the costs at the M points is approximately equal to the joint budget; and
during the time period:
(a) tracking a spending of the individual budgets, to determine remaining individual budgets,
(b) periodically updating the future ROI functions and the individual budgets, based on newly-accumulated historical data associated with the M online ad entities and on the remaining individual budgets, and
(c) periodically adjusting, in an online advertising platform, a spending pace of the remaining individual budgets, wherein the adjusting is based on the updated future ROI functions and the updated individual budgets.

2. The method according to claim 1, wherein the forecasting of the future ROI function of each of the M online ad entities comprises:
fetching the historical data associated with the M online ad entities, wherein the historical data comprises historical cost time-series and historical revenue time-series;
correlating the historical revenue time-series to the historical cost time-series, to produce correlated historical data; and
applying a nonlinear curve fitting algorithm to the correlated historical data, to produce a nonlinear function approximately descriptive of the correlated historical data, wherein, in the nonlinear function, revenue is a function of cost, and wherein the nonlinear function is the future ROI function.

3. The method according to claim 2, further comprising using the at least one hardware processor for computing error bounds of the nonlinear function, based on residuals of the application of the nonlinear curve fitting algorithm to the correlated historical data.

4. The method according to claim 1, wherein the time period is selected from the group consisting of: up to a week, up to multiple weeks, up to a month and up to multiple months.

5. The method according to claim 1, further comprising using the at least one hardware processor for receiving a schedule of one or more future business events expected to occur during the time period, wherein the adjusting is further based on the schedule.

6. The method according to claim 5, wherein the receiving of the schedule comprises receiving a business prediction as to each of the one or more future business events.

7. The method according to claim 1, wherein the adjusting of the spending pace of the remaining individual budgets comprises adjusting bids associated with at least one of the M online ad entities.

8. The method according to claim 1, wherein the M online ad entities are each selected from the group consisting of: an individual ad, a group of ads, a campaign and a set of campaigns.

9. A computer program product for temporal budget optimization in online advertising, the computer program product comprising a non-transitory computer-readable storage medium having program code embodied therewith, the program code executable by at least one hardware processor for:
receiving a user selection of a time period in the future and of a joint budget for M online ad entities, wherein M≧2;
forecasting, based on historical data associated with the M online ad entities, a future return on investment (ROI) function of each of the M online ad entities, wherein the future ROI function provides revenue as a function of cost;
computing individual budgets for the M online ad entities for the time period, by finding M points to serve as the individual budgets, each of the M points being a certain cost in the future ROI function of a different one of the M online ad entities, such that:
(i) the M points have approximately equal derivatives, and
(ii) a sum of the costs at the M points is approximately equal to the joint budget; and
during the time period:
(a) tracking a spending of the individual budgets, to determine remaining individual budgets,
(b) periodically updating the future ROI functions and the individual budgets, based on newly-accumulated historical data associated with the M online ad entities and on the remaining individual budgets, and
(c) periodically adjusting, in an online advertising platform, a spending pace of the remaining individual budgets, wherein the adjusting is based on the updated future ROI functions and the updated individual budgets.

10. The computer program product according to claim 9, wherein the forecasting of the future ROI function of each of the M online ad entities comprises:
fetching the historical data associated with the M online ad entities, wherein the historical data comprises historical cost time-series and historical revenue time-series;
correlating the historical revenue time-series to the historical cost time-series, to produce correlated historical data; and
applying a nonlinear curve fitting algorithm to the correlated historical data, to produce a nonlinear function approximately descriptive of the correlated historical data, wherein, in the nonlinear function, revenue is a function of cost, and wherein the nonlinear function is the future ROI function.

11. The computer program product according to claim 10, wherein the program code is further executable by said at least one hardware processor for computing error bounds of the nonlinear function, based on residuals of the application of the nonlinear curve fitting algorithm to the correlated historical data.

12. The computer program product according to claim 9, wherein the time period is selected from the group consisting of: up to a week, up to multiple weeks, up to a month and up to multiple months.

13. The computer program product according to claim 9, wherein the program code is further executable by said at least one hardware processor for receiving a schedule of one or more future business events expected to occur during the time period, wherein the adjusting is further based on the schedule.

14. The computer program product according to claim 13, wherein the receiving of the schedule comprises receiving a business prediction as to each of the one or more future business events.

15. The computer program product according to claim 9, wherein the adjusting of the spending pace of the remaining individual budgets comprises adjusting bids associated with at least one of the M online ad entities.

16. The computer program product according to claim 9, wherein the M online ad entities are each selected from the group consisting of: an individual ad, a group of ads, a campaign and a set of campaigns.

17. A system for temporal budget optimization in online advertising, the system comprising:
at least one hardware processor; and
a non-transitory computer-readable storage medium having program code embodied therewith, the program code executable by said at least one hardware processor for:
receiving a user selection of a time period in the future and of a joint budget for M online ad entities, wherein M≧2;
forecasting, based on historical data associated with the M online ad entities, a future return on investment (ROI) function of each of the M online ad entities, wherein the future ROI function provides revenue as a function of cost;
computing individual budgets for the M online ad entities for the time period, by finding M points to serve as the individual budgets, each of the M points being a certain cost in the future ROI function of a different one of the M online ad entities, such that:
(i) the M points have approximately equal derivatives, and
(ii) a sum of the costs at the M points is approximately equal to the joint budget; and
during the time period:
(a) tracking a spending of the individual budgets, to determine remaining individual budgets,
(b) periodically updating the future ROI functions and the individual budgets, based on newly-accumulated historical data associated with the M online ad entities and on the remaining individual budgets, and
(c) periodically adjusting, in an online advertising platform, a spending pace of the remaining individual budgets, wherein the adjusting is based on the updated future ROI functions and the updated individual budgets.

18. The system according to claim 17, wherein the forecasting of the future ROI function of each of the M online ad entities comprises:
fetching the historical data associated with the M online ad entities, wherein the historical data comprises historical cost time-series and historical revenue time-series;
correlating the historical revenue time-series to the historical cost time-series, to produce correlated historical data; and
applying a nonlinear curve fitting algorithm to the correlated historical data, to produce a nonlinear function approximately descriptive of the correlated historical data, wherein, in the nonlinear function, revenue is a function of cost, and wherein the nonlinear function is the future ROI function.

19. The system according to claim 18, wherein the program code is further executable by said at least one hardware processor for computing error bounds of the nonlinear function, based on residuals of the application of the nonlinear curve fitting algorithm to the correlated historical data.

20. The system according to claim 17, wherein the time period is selected from the group consisting of: up to a week, up to multiple weeks, up to a month and up to multiple months.

21. The system according to claim 17, wherein the program code is further executable by said at least one hardware processor for receiving a schedule of one or more future business events expected to occur during the time period, wherein the adjusting is further based on the schedule.

22. The system according to claim 21, wherein the receiving of the schedule comprises receiving a business prediction as to each of the one or more future business events.

23. The system according to claim 17, wherein the adjusting of the spending pace of the remaining individual budgets comprises adjusting bids associated with at least one of the M online ad entities.

24. The system according to claim 17, wherein the M online ad entities are each selected from the group consisting of: an individual ad, a group of ads, a campaign and a set of campaigns.

25. A method for temporal budget optimization in online advertising, the method comprising using at least one hardware processor for:
receiving a user selection of a time period in the future;
computing an optimal budget distribution between M online ad entities, wherein said computing comprises:
(a) forecasting, based on historical data associated with the M online ad entities, future return on investment (ROI) functions of the M online ad entities for the time period, wherein each of the future ROI functions provides revenue as a function of cost,
(b) finding M points to serve as the individual budgets, each of the M points being on a certain cost in the future ROI function of a different one of the M online ad entities, such that the M points have approximately equal derivatives;
forecasting, based on the M points found, a joint future ROI function of the M online ad entities;
receiving a user selection of a certain point on a graph of the future joint ROI function, and setting a cost at the certain point as a joint budget for the M online ad entities for the time period;
determining the individual budgets based on the user selection of the point on the graph of the future joint ROI function; and
during the time period:
(c) tracking a spending of the individual budgets, to determine remaining individual budgets,
(d) periodically updating the future ROI functions and the individual budgets, based on newly-accumulated historical data associated with the M online ad entities and on the remaining individual budgets, and
(e) periodically adjusting, in an online advertising platform, a spending pace of the remaining individual budgets, wherein the adjusting is based on the updated future ROI functions and the updated individual budgets.
